(19) United States
(12) Patent Application Publication
(10) Pub. No.: US 2003/0110717 A1
(43) Pub. Date: Jun. 19, 2003

(54) Flood and debris protection device hereafter known as "The Door Damm"

(76) Inventor: Dennis N. Rodriguez, Tampa, FL (US)

Correspondence Address: Dennis N. Rodriguez, 4534 W. Burke St., Tampa, FL, 33614, US

(21) Appl. No.: 10/243,442

(22) Filed: Sep. 14, 2002

Related U.S. Application Data
(60) Provisional application No. 60/322,796, filed on Sep. 17, 2001.

(51) Int. Cl. E06B 3/26; E06B 3/28

(52) U.S. Cl. 52/202; 52/203

(57) ABSTRACT

An improved and inexpensive flood and debris protection device “The Door Damm” (FIG. 2) provides consumers with an easily installed and removable waterproof and debris barrier for exterior windows and doors for temporarily protecting a structure against flood water and debris from entering a building or structure. The Door Damm is designed to be installed over all exterior material and structural surfaces however, for further protection the device can also be installed over wet or dry surfaces areas. The “Door Dam” (FIG. 1) main components consist of a rectangular frame pipe of a square steel metal or other suitable material (7), aluminum cover or panel (8),) secured to each other and bolted to the structural frame tightened by a spring-loaded tension bar (9) and sealed with a waterproofing putty like sealant.

This application claims the benefit of PPA Ser. No. 60/322,796 filed Sep. 17, 2001 by the present inventor

### CLASSIFICATION DEFINITIONS

This present invention is the latest flood and debris protection device which provides consumers with a waterproof and debris barrier for exterior windows and doors to prevent flood water and debris from entering a building.

### BACKGROUND OF THE INVENTION

Permanent flood protection devices such as levies are well known. However, it is often necessary to create a temporary, emergency barrier to flooding. Historically, the emergency barrier of choice has been the sandbag. However, sandbags have a number of drawbacks. They are extremely labor intensive and time-consuming to fill and transport to the site where they are to be used. Moreover, suitable fill material may not always be available in sufficient quantity. Still further, when the bags are no longer needed, a way must be found to dispose of and/or remove the fill material—another time-consuming and labor intensive activity and one that will require the presence of a suitable dumping area for the fill material.

While they are effective to keep out the flood waters for an initial period, sandbags soon become waterlogged and allow water to enter the building. The provision of permanent raised thresholds against flood waters is an inconvenience in the use of the building, as it restricts access of the building. With the construction of a sandbag levy, you are also congesting the traffic in the area of the flooding.

Although several types of flood devices have been proposed for example, in U.S. Pat. No. 593,973 (1992) Koeninger, it was designed as a doorway flood barrier, it has an inflatable tube in the device, with could deflate and cause considerable damage to the property. And the air placed in the device could cause movement in the panel. Adhesive bond can not be applied under wet conditions to give total protection.

### DISCUSSION OF THE BACKGROUND

Not all of the damage done to a building by flooding is caused by the flood waters themselves, but by the deposition of sediments carried in the flood waters, and contamination by micro-organisms present in the flood waters. In areas susceptible to periodical flooding, such as building set close to rivers or near the sea, conventional measures adopted to attempt to prevent the ingress of flood waters or tidal surges include the placing of temporary barriers across the doorways of building, or the erection of permanent raised thresholds which extend above the expected level of the water. The most commonly used temporary barrier is a sandbag barrier, which must be placed in position before flood water rises over the threshold height.

### BACKGROUND OF INVENTION—OBJECT AND ADVANTAGES

The Door Damm is the latest flood and debris protection device. It provides consumers with a waterproof barrier and debris protection for exterior doors and windows, to prevent the entry of water and debris in to the interior of a home or commercial building, when low level flooding occurs. The Door Damm is practical and potentially indispensable for protection one's home or business, this new product is functionally, cost effective and simple to use for the average consumers.

The Door Damm fits the need that existed for a flood and debris protection, this system and method wherein the device can be more easily, quickly secured into position when needed. Still further, a need existed for a flood and debris protection device and method that can be relatively easily removed and stored when no longer needed. The Door Damm can be installed over a wet surface area.

Because the Door Damm has never appeared on the market before, research can only seeks to identify demand potentiality that can be anticipated by a product of this nature. The flood protective device is strong and durable, and it's composed of rubber, steel, aluminum, metal or such suitable materials, as well as a waterproof putty type sealant.

As a result of high water caused by bad weather, the insurance industry pays out millions of dollars a year in claims for minor flooding of homes and commercial office building. Up until now, even the smallest amount of flooding in a home of office could cause thousands of dollars in damage. The Door Damm saves property owners and insurers millions of dollars by preventing minor flood damage, because the high water barricade provides a waterproof barrier that prevents the entry of floodwater through exterior doors and windows.

Indeed, this newly introduced product is a clever addition to the market because it furnishes consumer with an inexpensive, reliable method for flood protecting one's property. The tangible consumer demand of the Door Damm and its genuine utility attests to its corresponding potentiality in the prevailing market.

The Door Damm provides basic usefulness and is inherently utile, because doors and windows are temporarily debris proofed and waterproofed by the frame pipe portion, which will face the door to be covered. The frame pipe portion of the Door Damm is then situated in the doorway or window opening jamb or the exterior of the door or window opening with the putty type sealant.

### SUMMARY

The Door Damm is the latest flood and debris protection device, that is easy to use, cost effective and a reliable method for flood protecting one's property.

### BRIEF DESCRIPTION OF THE SEVERAL VIEWS OF THE DRAWINGS

The invention will now be described in more detail, reference being make to the accompanying drawings, in which

FIG. 1 is a general perspective view showing the major components required to make up the flood and debris device in accordance with the present invention.

FIG. 2 is a general perspective view illustrating the flood and debris protective device ready to be installed.

FIG. 3 is a general perspective view illustrating the flood and debris protective device properly installed on a door, in use.

FIG. 4 is a general perspective view illustrating of the flood and debris protective device properly installed on a window, in use.

FIG. 5 is a general perspective view illustrating of the flood and debris protective device properly installed on a glass sliding door, in use.

FIG. 6 is a general perspective view illustrating of the protective flood and debris device properly installed on a garage door, in use.

### DRAWINGS—REFERENCE NUMERALS

7 frame pipe

8 cover or panel

9 spring-loaded tension bar

10 “L” brace or bracket

11 screws

12 putty like sealant

13 rubber sealant

### DETAILED DESCRIPTION OF THE PREFERRED EMBODIMENT

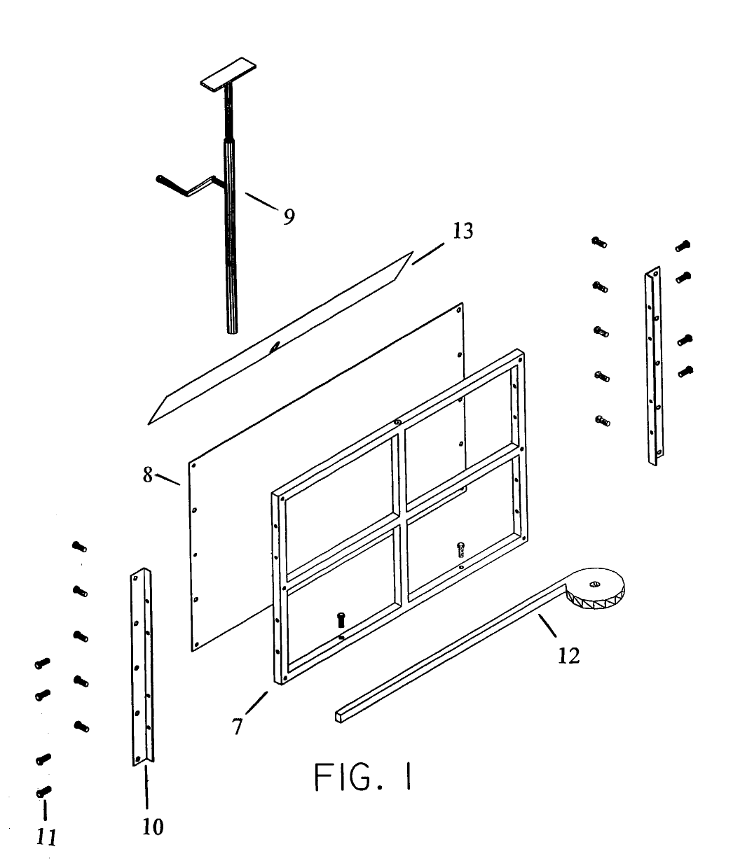

The present invention comprises a flood and debris control device for doors and windows for residential and commercial use. FIG. 1 illustrates the major components required to make up the flood protection device in accordance with the present invention. The mechanism consists of a frame pipe portion 7 and a cover portion 8. The frame pipe 7 is a rectangular shape and is made in standard sizes to fit most door and window jambs. However, custom made sizes will be available if needed.

The frame pipe 7 itself is composed of a square steel metal, or other suitable material, frame pipe 7. The word “doorway” or “window frame” hereafter refers to an opening in which the door or window is mounted and which the door closes into when shut and the window is installed into.

The frame pipe 7 is bolted by screws 11 into the doorway or window frame along the horizontal sides of the frame of on the interior of the doorway or window jamb. The frame pipe 7 might included an “L” brace or bracket 10 that is connected to the frame pipe 7 that then extended out over the doorway or window opening into the frame pipe 7 or side of the door or window, for additional protection.

A spring-loaded tension bar 9 is situated in the top center of the frame pipe 7 for holding the frame pipe 7 in place over the door or window bottom. Under certain installation the spring-loaded tension bar 9 may not be needed. The frame pipe 7 is also bolted, with screws 11, into the door jamb or window ledge at the bottom of the door or window frame. When the Door Damm is not in use the screw holes can be covered with a hole-protector, purchased at any hardware store, available in all color, to hide the intrusion into the building or frame.

The cover or front panel 8 is a rectangle sectional shape and is made of aluminum sheet metal, or other suitable materials, and when needed is made sufficiently wider to extend past any discontinuity gap between the respective door and window frame. This provides coverage for these areas, precluding water and debris, from intrude into the building, this provides additional protection. The cover or panel 8 can be welded or bolted with screws11 into the frame pipe 7 portion, covering it and creating a waterproof barrier. On the top of the cover is a rubber sealant 13 that protects the device from water and debris intrusion. The frame pipe 7 and cover or panel 8 is attached and sealed with a tape of putty like sealant 12.

FIG. 2 is the components of the Door Damm ready for installation into the window. All of the components and installation directions in FIG. 1 are correct and the frame pipe 7 does include the “L” brace 10.

FIG. 3 is the Door Damm installed into a door. All of the components and installation directions in FIG. 1 are correct and this frame pipe 7 illustration does include the “L” brace 10.

FIG. 4 is the view of the Door Damm installed into a window. All of the components and installation directions in FIG. 1 are correct and this frame pipe 7 illustration does include the “L” brace 10.

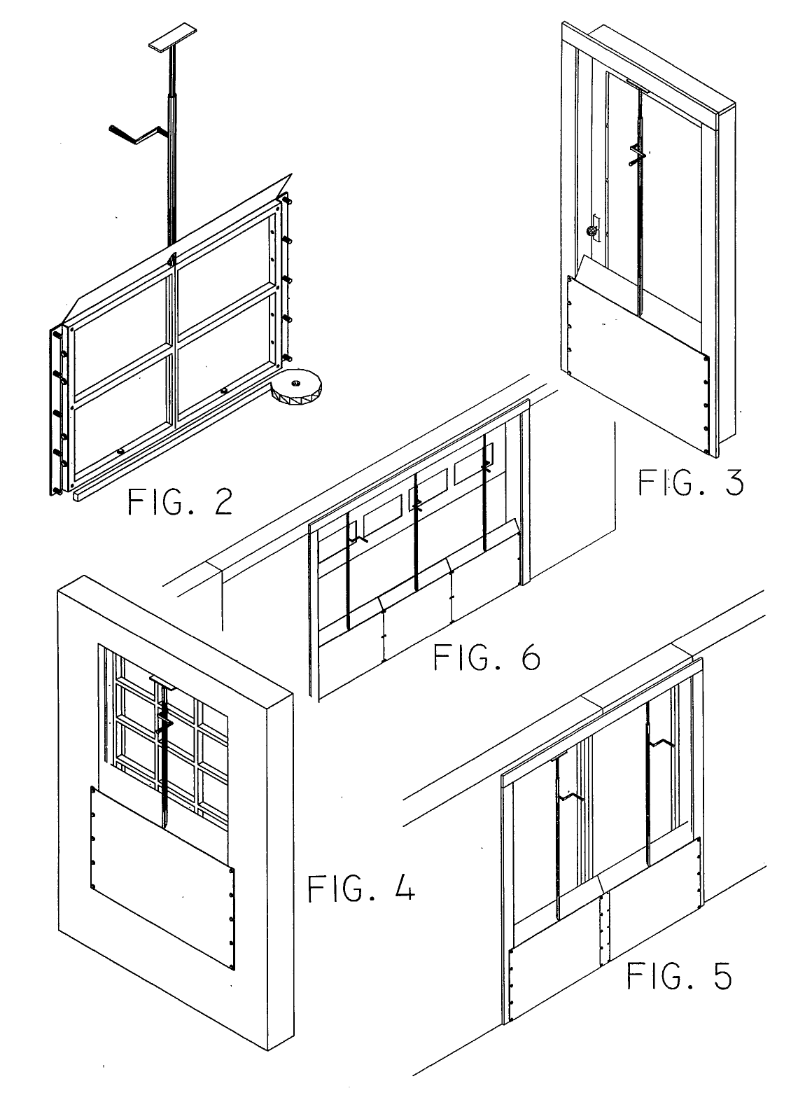

FIG. 5 is the illustration of the Door Damm installed on a sliding glass door. Most all of the components and installation directions in FIG. 1 are correct and this illustration does include the “L” brace 10. However, except the only difference with this illustration and FIG. 1 above is that the cover or panels 8 are connected together in the middle of the panel with a “T” brace similar to the “L” brace 10. Or the cover or panels 8 can be manufactured to be one large panel to cover the entire sliding door.

FIG. 6 is the illustration of the Door Damm installed on a garage door. Most all of the components and installation directions in FIG. 1 are correct and this illustration does include the “L” brace 10. However, except the only difference with this illustration and FIG. 1 above is that the cover or panels 8 are connected together in the middle of the panel with a “T” brace similar to the “L” brace 10. Or the cover or panels 8 can be manufactured to be one large panel to cover the entire garage door.

Accordingly, the Door Damm is conceived according to rigorous guidelines, and is also assured to be of quality materials and distinctive design. The inherent usefulness of the Door Damm will encourage consumers to purchase this product, because they are interested in flood and debris protection systems. Indeed, because of the necessity of disaster readiness and popularity of home improvement, this water and debris barrier protection apparatus should attract homeowners, businessmen and public administrators.

Although the illustrated embodiments of the present invention have shown, described and pointed out the fundamental novel feathers of the invention, as applied to theses embodiments, it will be understood that various omissions, substitutions and changes in the form of the detail of the device illustrated may be make by those skilled in the are without departing from the spirit of the present inventions. Consequently, the scope of the invention should not be limited to the foregoing description, but should be defined by the appended claims.

It is to be understood that the present invention is not limited to the embodiments described above, but encompasses any and all embodiments within the scope of the following claims.

Numerous modification and adaptations of the present invention will be apparent to those so skilled in the art and thus, it is intended by the following claims to cover all such modifications and adaptations with fall within the true spirit and scope of the invention.

[image]

[image]

[image]

[image]

[image]

[image]

[image]

[image]

[image]

[image]

[image]

What I claim as my invention is:

1. A new and improved flood and debris protective device for windows and doors, to close an opening in a building against the passage of debris and flood water through the opening, the device comprising: a flood and debris protective device that is strong and durable, easy to use, inexpensive and is composed of rubber, steel, aluminum, metal or such suitable materials, as well as waterproof putty type sealant.

2. The improved flood and debris protective device according to claim 1, wherein:
a mechanism consists of a frame pipe that is rectangular and is made in standard sizes to fit most door and window jambs.

3. The improved flood and debris protective device as defined in claim 2, wherein: a custom size flood device is available to fit a non-standard structure.

4. The improved flood and debris protective device as defined in claim 2 wherein an “L” brace or bracket can be used to provide additional coverage by extending the frame to cover the outer portions of the frame of the windows or doors.

5. The improved flood and debris protective device as defined in claim 1, wherein further strength is given to the device by the bolting system on the thrush hold and horizontal portion of the cover or panel.

6. The improved flood and debris protective device for use in flooding, said device comprising: a spring-loaded tension bar is situated in the top center of the frame for holing the frame pipe in place over the door or window bottom.

7. The improved flood and debris protective device for use in flooding, said device comprising: the cover or panel portion consists of a rectangle sheet metal, which is welded or bolted in to the frame on the exterior portion of the structural covering it and creating a waterproof barrier.

8. The improved flood and debris protective device for use in flooding, said device comprising: of the putty type sealant, which can also be applied even to a wet surface, therefore the Door Damm can be installed under the wettest conditions.
